(19) United States
(12) Patent Application Publication
(10) Pub. No.: US 2014/0030383 A1
(43) Pub. Date: Jan. 30, 2014

(54) DEVICE FOR SUPPLYING WATER AND SODA

(71) Applicant: Roberto Marchetti, Modena (IT)

(72) Inventor: Roberto Marchetti, Modena (IT)

(21) Appl. No.: 13/985,102

(22) PCT Filed: Feb. 16, 2012
(86) PCT No.: PCT/IB12/00271

§ 371 Date: Oct. 21, 2013

(30) Foreign Application Priority Data
Feb. 17, 2011 (IT) MO2011A000035

(51) Int. Cl. B01F 3/04; A23L 2/54

(52) U.S. Cl. CPC B01F 3/04808; A23L 2/54
USPC 426/67; 261/133; 99/323.1

(57) ABSTRACT

The device for supplying water and soda, includes at least a water feeding line (2), at least a water tank (3) connected to the water feeding line (2), at least a pressurized CO₂ tank (4), at least a soda tank (5), elements for transferring (6) water from the water tank (3) into the soda tank (5), elements for injecting (7) CO₂ from the CO₂ tank (4) into the soda tank (5) in order to mix CO₂ with water and obtaining soda, first supplying elements (8) communicating with the water tank (3) for supplying water towards outside, second supplying elements (9) communicating with the soda tank (5) for supplying soda towards outside and cooling elements (20) interposed between the water tank (3) and the soda tank (5).

### TECHNICAL FIELD

The present invention relates to a device for supplying water and soda.

### BACKGROUND ART

In the present disclosure, with the term “soda” it is intended water mixed with CO₂.

The known devices for supplying water and soda generally comprise a water feeding line connected to the fixed domestic water pipe, a water tank that is feed by the feeding water line, a pressurized CO₂ tank, separated from the water tank, that is also feed by the feeding water line in order to obtain soda, and means for supplying water/soda towards outside in a continuous way.

More particularly, these devices comprise an high pressure pump in order to be able to inject water from the feeding water line into the pressurized CO₂ tank. Therefore, the flow rate of water towards the CO₂ tank is very high, and in particular is much higher than the flow rate during pouring the water into the caps.

These devices are also provided with sensor means suitable to recall water from the feeding line so that soda and water are always available for the supply.

More particularly, the water tank is positioned around the CO₂ tank and cooling means are usually positioned outside the water tank, in order to lower the water and the soda temperature. Indeed, the water that is fed into the water tank and into the CO₂ tank has to be cooled from the ambient temperature (20-25° C.) to the served temperature of around 5° C.

This kind of device presents some drawbacks.

Indeed, the transferring of water from the feeding water line into the pressurized CO₂ tank involve a complex layout and high cost of production and maintenance. Furthermore, the high pressure of work stress significantly the device components, which therefore can be damaged, and require the presence of safety means to prevent the occurrence of dangerous accident.

Moreover, the known devices of the type above described doesn't allow the exploitation of an efficient purification of the water.

Indeed, for obtaining an efficient purification, for example by means of UV rays, the water flow rate through the water pump have not to exceed the value of 2 lt/min.

It is neither possible to obtain an efficient UV purification after the mixing of water and CO₂, because the presence of bubbles prevent the complete irradiation of the liquid by forming a barrier; moreover in this case the purification would interest only the soda and not the water too.

In addition, the known technology can't allow the option to control and regulate the CO₂ concentration into the soda and therefore the taste of the latter.

Another drawback of the known devices is that they present a low cooling efficiency.

More particularly, a part of the cooling energy is lost in the surrounding environment and the soda temperature results higher than the water temperature, due to the heat lost for cooling water into the water tank and to the fact that the water introduced into the CO₂ tank is at ambient temperature.

A further drawback of this kind of device is that they have to be necessarily connected to the domestic water pipe. This fact limit significantly the use of these devices, because they can be used or positioned only in the rooms provided with a water tap connected to the domestic water line.

Another device already in commerce is called soda carbonator.

This kind of device comprises only a CO₂ tank and means for supplying CO₂ from the CO₂ tank towards outside and, particularly, in an external and removable bottle of water.

Therefore, the soda carbonator is not suitable to supply soda and/or water but it is only suitable to supply CO₂. More particularly, the soda carbonator device doesn't supply water, because water has to be furnished by the user by applying an external bottle that is not part of the device itself.

It is evident that the soda carbonator doesn't treat water, and indeed it doesn't have any tank suitable to receive water, but it is only adapted to inject CO₂ into an external water tank furnished by the user and which has to be removed from the device itself in order to access its contents.

Also this kind of devices presents some drawbacks.

More particularly, the lack of a water tank doesn't allow the preparation of soda in a continuous way because, after the supplying of CO₂, the bottle of water have to be substituted with another one in order to perform a subsequent supply. Another drawback of soda carbonator consists in that it doesn't allow to purify the soda so obtained. This is due to the fact that water is not treated by the device but is inserted from time to time by the user.

Furthermore, the user tends to repeatedly use the same unpurified bottles.

Another drawback of this kind of devices consists in that they neither allow to cool soda because they are not provided with any cooling device. Indeed, the temperature of the soda prepared with soda carbonators depends only by the temperature of the water furnished by the user and positioned under the carbonator itself.

A further drawback of soda carbonator is that it doesn't allow to supply cold water in alternative from the soda.

### DESCRIPTION OF THE INVENTION

The main aim of the present invention is to provide a device for supplying both water and soda that doesn't require the presence of an high pressure pump.

Within such aim, one object of the present invention is to provide a device that is less complex and less expensive, both in construction and maintenance, with respect to the known devices.

One object of the present invention is to provide a device that allow the continuous supply of both water and soda and, in the meantime, allow the customer to adjust the quantity of CO₂ supplied, and therefore the strength of soda, according to his taste.

Another object of the present invention is to provide a device which allows to achieve a more efficient cooling with respect to the known devices of both water and soda.

Yet another object of the present invention is to obtain an efficient purification of both water and soda.

A further object of the present invention is to provide a device which presents a wide flexibility of use and which should not necessarily be connected to the fixed line of domestic water.

Not the last object of the present invention is to provide the user with information relating to the need to replace the container of CO₂ before it runs out of the whole.

The aforementioned objects are achieved by the present device for supplying water and soda, comprising:
at least a water feeding line;
at least a water tank connected to said water feeding line;
at least a pressurized CO₂ tank;
at least a soda tank separated from both said water tank and said CO₂ tank, where the soda tank is positioned around said water tank or viceversa;
means for mixing water with CO₂ for obtaining soda which comprise means for transferring water from said water feeding line into said soda tank and means for injecting CO₂ from said CO₂ tank into said soda tank;
first supplying means communicating with said water tank for supplying water towards outside;
second supplying means communicating with said soda tank for supplying soda towards outside;
   and characterized in that it comprises cooling means interposed between said water tank and said soda tank.

The aforementioned objects are furthermore achieved by the present Method for preparing water and soda, characterised on the fact of comprising the following steps of:
furnishing at least a water tank;
furnishing at least a soda tank;
furnishing at least a CO₂ tank;
filling said water tank and said soda tank with water;
injecting CO₂ from said CO₂ tank into the water contained in said soda tank for obtaining soda;
contemporary cooling the water contained in said water tank and the soda contained in said soda tank.

### BRIEF DESCRIPTION OF THE DRAWINGS

Other characteristics and advantages of the present invention will become more evident from the description of a preferred, but not sole, embodiment of a device for supplying water and soda, illustrated purely as an example but not limited to the annexed drawings in which:

FIG. 1 is a schematic representation of the hydraulic scheme of a device according to the invention;

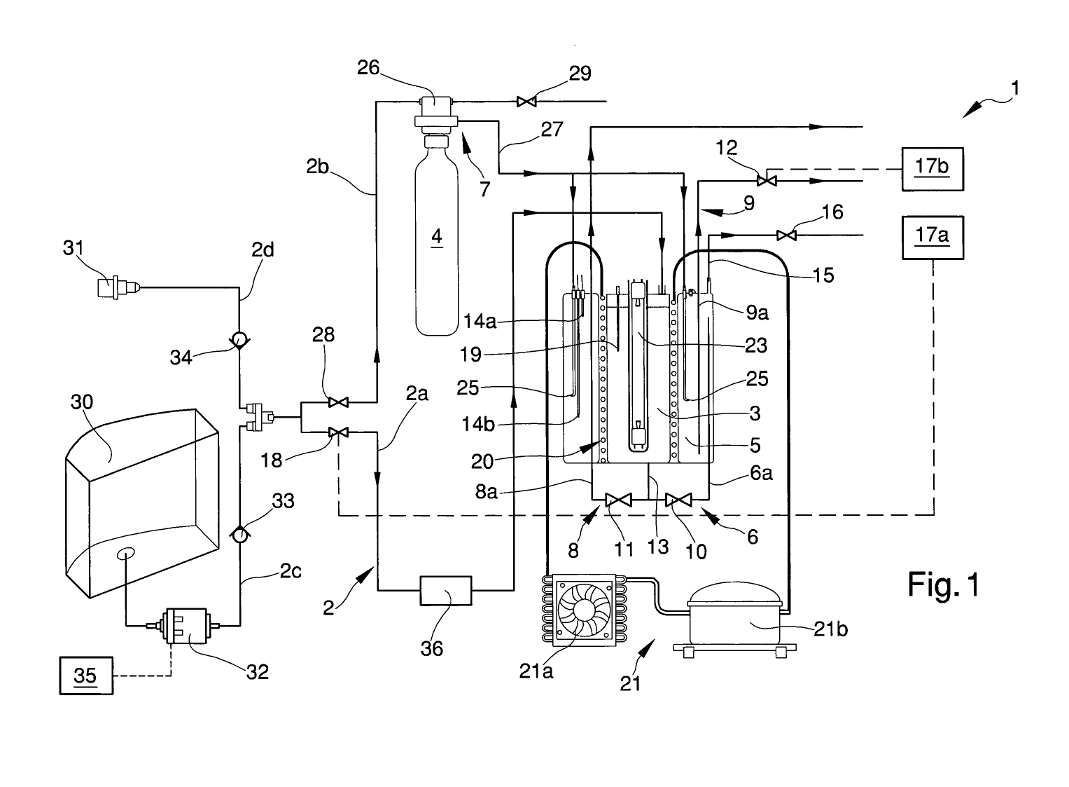

FIG. 2 is a section of the water and soda tank assembly of a device according to the invention;

FIG. 3 is a section of the control valve of a device according to the invention.

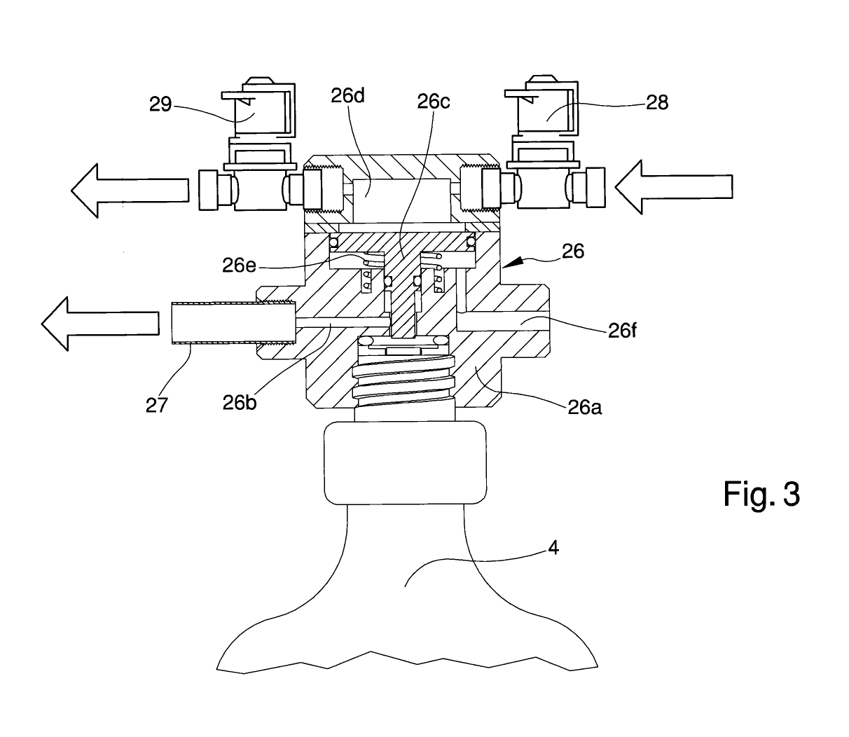

### EMBODIMENTS OF THE INVENTION

With particular reference to such figures, globally indicated by reference number 1 is a device for supplying water and soda according to the invention. The device 1 comprises at least a water feeding line 2, at least a water tank 3 connected to the feeding line 2, at least a pressurized CO₂ tank 4 and means for mixing 6, 7 water with CO₂ for obtaining soda.

More particularly, the feeding line 2 comprises at least a first valve 18 controllable for allowing/preventing the water flow towards the water tank 3. The device 1 further comprises at least a soda tank 5 and the means for mixing 6, 7 comprise means for transferring 6 water from the feeding line 2 into the soda tank 5 and means for injecting 7 CO₂ from the CO₂ tank 4 into the soda tank 5.

The device 1 also comprises first supplying means 8 of water, communicating with the water tank 3 for supplying water towards outside, and second supplying means 9 of soda, communicating with the soda tank 5 for supplying soda towards outside.

More particularly, the device 1 comprises two separated tank adapted to contain a liquid, of which the water tank 3 and the soda tank 5, and a CO₂ tank 4 separated from both the water and the soda tank 3 and 5.

Advantageously, the soda tank 5 is positioned around the water tank 3 or viceversa.

In the form of embodiment represented in the figures, the soda tank 5 is positioned around the water tank 3.

More particularly, the soda tank 5 has a ring shape and the water tank 3 is positioned in the hole defined by the soda tank itself.

Suitably, the transferring means 6 are interposed between the water tank 3 and the soda tank 5 in order to convey water from the water tank 3 into the soda tank 5. More in detail, the transferring means 6 comprise at least a tube 6a communicating with both the water tank 3 and the soda tank 5, and at least a second valve 10, positioned along the tube 6a, that is controllable for allowing/preventing water flow from the water tank 3 towards the soda tank 5. Preferably, the second valve 10 is of the normally closed type.

Similarly, the first and the second supplying means 8 and 9 comprise respective tubes 8a and 9a on which are positioned, respectively, a third and a fourth valve 11 and 12 controllable for allowing and/or preventing the flow of water and soda from the respective tanks towards outside.

Preferably, the third valve 11 is of the normally open type, while the fourth valve 12 is of the normally closed type.

Advantageously, the first and second supplying means 8 and 9 comprise, respectively, first and second command means 17a and 17b operable by a user for supplying water and soda from the respective tanks 3 and 5 towards outside. More particularly, the first command means 17a are operatively connected to the first valve 18 so that, when the first command means themselves are activated by the user, the first valve 18 is opened and the water that flows from the feeding line 2 towards the water tank 3 pushes the water here contained towards outside, passing through the third valve 11 and maintaining, in the meantime, the water tank 3 full of water.

Similarly, the second command means 17b are operatively connected to the fourth valve 12 so that, when the second command means themselves are activated by the user, the fourth valve is opened and soda flows from the soda tank 5 towards outside by means of the CO₂ pressure injected into the soda tank itself.

The device 1 also comprises a floating valve, not showed in the figures, placed at the top of the water tank 3 and suitable to release towards outside the air contained in the latter during its filling with water. This floating valve close itself automatically when it is reached by water.

In the preferred form of embodiment showed in the figures, the first supplying means 8 and the transferring means 6, and more particularly their tubes 6a and 8a, presents a common branch 13 communicating with the water tank 3 and with both the second and third valves 10 and 11. The common branch 13 is disposed upstream of the valves 10 and 11 with respect to the direction of water flow from the water tank 3 towards the soda tank 5 and towards outside. Suitably, inside the soda tank 5 are disposed at least a couple of level sensor, of which an high level sensor 14a and a low level sensor 14b. When the water level inside the soda tank 5 reaches or goes below the low level sensor 14b, it recalls water from the water tank 3.

More in detail, the high and low level sensors 14a and 14b are operatively connected with the first valve 18, with the second valve 10 and with the third valve 11.

More in particular, when the water level reaches or decrease below the low level sensor 14b, the latter is adapted to open the first and the second valve 18 and 10 and to close the third valve 11, for example by sending an electrical signal, so that the water flow from the feeding line 2 is conveyed into the soda tank 5 passing through the water tank 3. At the contrary, when the water level into the soda tank 5 reaches the high level sensor 14a, the latter is adapted to return the valves 18, 10 and 11 in their normal operating positions, so closing the first and the second valves 18 and 10 and opening the third valve 11.

Even if in the figures here attached the second and the third valves 10 and 11 are separated, it would be obvious for the skilled person to substitute these two valves with a single three way valve suitable for selectively connect the water tank 3 with the tube 8a or with the tube 6a. Such a three way valve, in normal operating conditions, is adapted to connect the water tank 3 with the tube 8a of the first supplying means 8.

Preferably, the device 1 also comprises an air release line 15, provided with a fifth valve 16 and communicating with the soda tank 5. The release line 15 is adapted to expel towards outside the CO₂ that remains in the soda tank 5 when the soda level reach or decrease under the low level sensor 14b. Therefore, the fifth valve 16 and the low level sensor 14b are operatively connected to each other. Moreover, the fifth valve 16 is also operatively connected with the high level sensor 14a, the latter being adapted to close the fifth valve 16 when it is reached by the water level present into the soda tank 5.

Suitably, the device 1 also comprises a temperature sensor 19 adapted to control the water temperature into the water tank 3 and/or into the soda tank 5.

More in detail, the temperature sensor 19 may be placed inside the water tank 3, as in the form of embodiments showed in the figures, or in the soda tank 5 or between them.

According to the invention, the device 1 comprises cooling means 20 interposed between the soda tank 5 and the water tank 3. The cooling means 20 are constituted, for example, by a cooling tube suitable to contain a cooling substance and connected to a cooling system 21 comprising, for example, a condenser 21a and a compressor 21b. Suitably, the cooling system 21 is operatively connected with the temperature sensor 19.

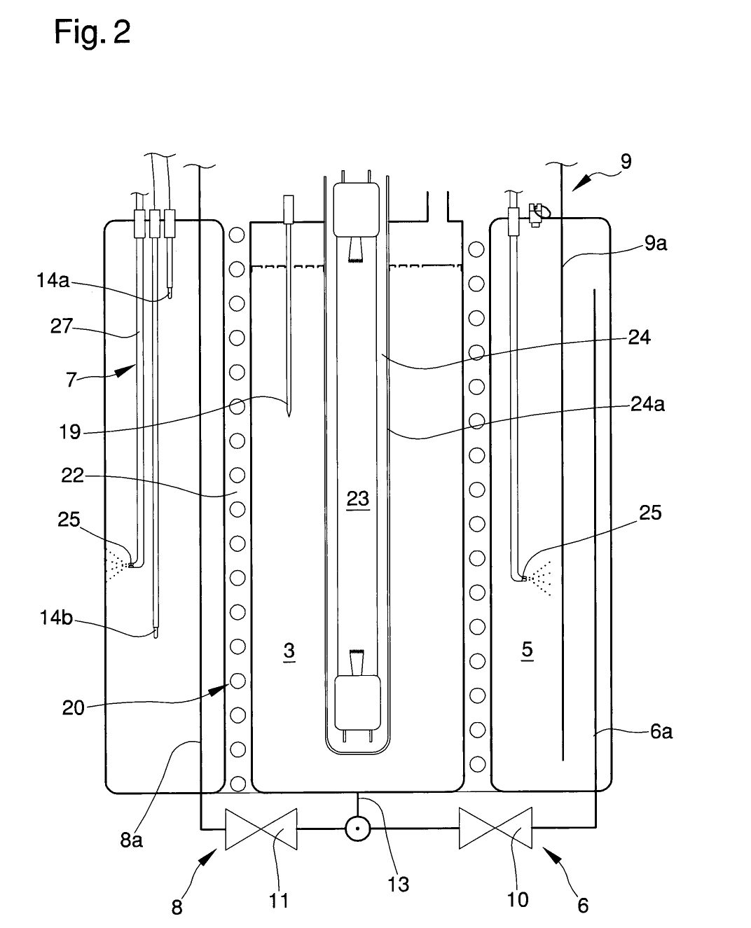

In the preferred form of embodiment showed in FIG. 2, between the water tank 3 and the soda tank 5 is interposed a cavity wall 22, isolated from both these tanks 3, 5. The cooling means 20 are seated inside the cavity wall 22 and are shaped in such a way to round at least a portion of the water tank 3. More in detail, the cooling tube 20 is spiral shaped in order to round the water tank 3 along its entire length.

Suitably, a thermal conductivity liquid is placed into the cavity wall 21 in order to reduce the thermal dispersion.

Such a disposition of the cooling means 20 allows to reduce heat dispersion because the cooling energy is captured by both the water tank 3 and the soda tank 5.

Advantageously, the device 1 comprises means for purifying 23 water disposed inside the water tank 3.

More particularly, the device 1 comprises a containment chamber 24, disposed inside the water tank 3 and isolated from it, inside which are inserted the purification means 23.

The containment chamber 24 is positioned substantially in the middle of the water tank 3, the latter being substantially ring-shaped.

Preferably, the purification means 23 comprise at least an IJV lamp and the wall 24a that separates the containment chamber 24 from the water tank 3 is made of a material at least partially transparent to the wavelength of UV radiations.

The presence of the purification means 23 inside the water tank 3 allow to purify the water here contained and, therefore, both the water and the soda supplied by the device 1.

Advantageously, the purification means 23 are operatively connected to the first valve 18, so as to activate themselves when the first valve 18 is opened, so purifying the water that is introduced time by time into the water tank 3. Different embodiments cannot however be ruled out wherein the purification means 23 are of different kind and well known by the person skilled in the art. The injecting means 7 comprise at least one nozzle 25 positioned inside the soda tank 5.

More in detail, in the preferred form of embodiment represented in FIG. 2, the injecting means 7 comprise a couple of nozzle 25 placed at opposite sides with respect to each other inside the soda tank 5 and oriented in opposite direction with respect to each other in order to create a vortex inside the soda tank, so improving the mixing between water and CO₂.

Preferably, the injecting means 7 comprise a control valve 26 associated to the CO₂ tank 4 and controllable for allowing/preventing CO₂ leakage from the CO₂ tank 4 into said soda tank 5.

More in detail, the CO₂ tank 4 is provided with an internal valve, not showed in the figures, of the normally closed-type; the control valve 26 is adapted to control the opening/closure of this internal valve.

The injecting means 7 also comprise a transport line 27 connected to the control valve 26 and adapted to convey CO₂ into the soda tank 5. In the form of embodiment represented in the figures, the transport line 27 defines the nozzles 25.

More particularly, the control valve 26 comprises a body 26a, associated to the CO₂ tank and inside which is defined at least a path 26b for the CO₂. The path 26b communicates with the soda tank 5 by means of the transport line 27. The control valve 26 also comprise at least a piston 26c inserted sliding inside the body 26a and movable between a first position, in which it is moved away from the CO₂ tank 4 that is closed, and a second position, in which it is approached to the CO₂ tank 4 for opening it. The piston 26c therefore opens the internal valve of the CO₂ tank 4 in the second position and allow its return in the closed configuration in the first position. The piston 26c, in its second position, causes the leakage of CO₂ from the CO₂ tank and the inlet of the same into the path 26b.

Between the piston 26c and the body 26a are interposed elastic means 26e adapted to contrast the movement of the piston itself from the first towards the second position. Therefore, the elastic means 26e push the piston 26c towards its first position.

Furthermore, the control valve 26 comprise a control chamber 26d, communicating with the piston 26c and connected to the feeding line 2, and means for controlling 28,29 the inlet/outlet of water into/from the control chamber 26d in order to moving the piston 26c from the first to the second position and vice versa. Preferably, the controlling means 28,29 comprise a couple of valve positioned at opposite side of the control chamber 26d of which a sixth valve 28 and a seventh valve 29 disposed upstream and downstream of the control chamber 26d with respect to the water flow respectively. More in detail, the sixth and the seventh valve 28 and 29 are controllable, respectively, for allowing/preventing water flow from the feeding line 2 towards the control valve 26 and for allowing/preventing water flow from the control valve 26 towards outside.

The control valve 26 further comprises an air release path 26f adapted to discharge outside the air contained into the body 26a during the movement of the piston 26c from the first position towards the second position.

Preferably, the injecting means 7 comprise a timer, not showed in the figures, that controls the opening/closing of the control valve 26. More in particular, this timer is operatively connected with the sixth and the seventh valves 28 and 29, in order to opening/closing them, so as to control the inlet/outlet of water into/from the control chamber 26d and, as a consequence, to control the movement of the piston 26c.

Suitably, the CO₂ tank 4 is pressurized at pressure substantially comprises between 5 and 15 bar, in order to inject CO₂ into the soda tank 5 at high speed for obtaining an efficient mixing of the CO₂ with water, in a very precise and short interval of time.

Advantageously, the feeding line 2 comprises a first branch 2a, connected to the water tank 3 and provided with the first valve 18, and a second branch 2b, connected to the control valve 26 and provided with the sixth valve 28.

In the embodiment represented in the figures, along the first branch 2a is also positioned a filter 36.

More in detail, the sixth valve 28 is operatively connected with the high level sensor 14a, for example by means of the timer above mentioned; the sixth valve 28 being opened only when the water contained in the soda tank 5 reaches the high level sensor 14a, i.e. when the soda tank 5 is full of water.

Preferably, the feeding line 2 is connected to a reservoir 30 isolated from the domestic water line, that is indicated in the figures with the tap water 31.

The device 1 comprises pumping means 32 for pumping water from the reservoir 30 into the feeding line 2.

Suitably, the reservoir 30 is of a the removable type for allowing the replenishment by the user.

Alternatively, the feeding line 2 is connected to the domestic water line 31.

In the preferred form of embodiment showed in the figures, the feeding line 2 is connected, respectively by means of a third and a fourth branches 2c and 2d, to both the reservoir 30 and the domestic water line 31. In this preferred form of embodiments the device 1 comprises control means 35 for enabling/disabling the pumping means 32. More particularly, the control means 35 are operable by the user and, for example, are adapted to send an electrical signal to the pumping means 32 for their enabling/disabling it.

Advantageously, the device 1 comprises at least a first and a second check valve, respectively identified in the figures with the reference numbers 33 and 34, positioned along the feeding line 2, more particularly along the third and the fourth branch 2c and 2d, for preventing water flow directed, respectively, towards the reservoir 30 and towards the domestic water line 31. More in detail, the first check valve 33, positioned along the third branch 2c, is adapted to prevent water flow from the domestic water line 31 towards the reservoir 30 and the second check valve 34, positioned along the fourth branch 2d, is adapted to prevent water flow from the reservoir towards the domestic water line 31.

The functioning of the device in the execution of the method according to the invention is described here below.

Suitably, before starting to prepare water and/or soda it is necessary to connect the feeding line 2 to the domestic water line 31 or to replenish the reservoir 30 with water; in the latter case it is necessary to enable the pump 32 by means of the control means 35.

It is therefore necessary to fill water into the water tank 3 and into the soda tank 5.

When the water tank 3 and the soda tank 5 are empty, the low level sensor 14b closes the third valve 11 and opens the first and the second valve 18 and 10. In this way, the water that flows through the first branch 2a fills simultaneously the water tank 3 and the soda tank 5 that, with the second valve 10 opened, communicate to each other by means of the transferring means 6. In this operating configuration, the water level into the water tank 3 and into the soda tank 5 is the same for the principle of communicating vessels.

When the water level into the soda tank 5 reaches the high level sensor 14a, the latter brings back the valves in their normal operating configurations, i.e. closes the first and second valves 18 and 10 and opens the third valve 11.

The method according to the invention further includes, in order to preparing soda, the step of injecting CO₂ from the CO₂ tank 4 into the soda tank 5, so mixing the CO₂ with the water here contained.

This step is performed by opening the control valve 26 associated to the CO₂ tank 5 when the soda tank 5 is full of water. More particularly, the sixth valve 28 is opened, for example by means of a signal emitted by the high level sensor 14a, so allowing water flow into the second branch 2b.

The water that flows through the second branch 2b enters into the control chamber 26d so pushing the piston 26c from its first position towards its second position. The movement of the piston 26c due to the water pressure inside the control chamber 26d opens the CO₂ tank 4 so causing the outcome of CO₂ and the inlet of the same into the CO₂ path 26b.

Therefore, CO₂ flows into the CO₂ path 26b and from it into the transport line 27 until it reaches the nozzle 25 by means of which enters into the soda tank 5. The particular disposition of the nozzle 25 above disclosed, by creating a vortex inside the soda tank 5, allow an efficient mixing of the CO₂ with the water.

When the quantity of CO₂ injected into the soda tank 5 is sufficient for obtaining the desired taste of soda, the seventh valve 29 is opened and the sixth valve 28 is closed, so draining the water contained in the control chamber 26d towards outside. More particularly the opening/closing of the sixth and seventh valves 28 and 29 is controlled by the timer above mentioned, not showed in the figures, that is adjustable by the user.

In this way, the pressure inside the control chamber 26d decrease, up to reach the ambient pressure, and the piston 26c moves back itself from its second position into its first position, so closing the CO₂ tank 4 and interrupting the CO₂ flow into the soda tank 5.

Therefore, inside the water tank 3 is contained water and inside the soda tank 5 is contained soda.

When the user activates the first command means 17a, the latter opens the first valve 18. In this way, the water that flows into the first branch 2a enters into the water tank 3 and pushes the water contained in the tube 8a towards outside by passing through the third valve 11 normally opened.

When the first command means 17a are disabled the first valve 18 is closed and the water flow into the water tank 3 is interrupted, so preventing water supply towards outside.

In the same way, when the user activates the second command means 17b, the latter opens the fourth valve 12 so allowing the supply of soda due to the pressure of CO₂ inside the soda tank 5.

When the second command means 17b are disabled, the fourth valve 12 is closed and the supply of soda is interrupted.

When the level of soda into the soda tank 5 reaches or goes below the low level sensor 14b, the latter opens the first and the second valves 18 and 10, closing in the meantime the third valve 11. In this way, the water that flows from the first branch 2a into the water tank 3 is conveyed into the soda tank 5. The first and the second valve 18 and 10 are closed, and the third valve 11 is opened, when the level into the soda tank reaches again the high level sensor 14a.

According to the invention, the present method also comprises the step of cooling the water and/or the soda contained, respectively, into the water tank 3 and into the soda tank 5. More in detail, the method comprises the step of contemporary cooling both the water and the soda contained, respectively, into the water tank 3 and into the soda tank 5.

This phase is performed by the cooling means 20 interposed between the water tank 3 and the soda tank 5 and operatively connected to the temperature sensor 19 placed inside the water tank 3. The cooling means 20 placed inside the cavity wall 22, and inside which flows a cooling substance, allow the refrigeration of both water and soda, so obtaining an high cooling efficiency.

Advantageously, the method further comprises the step of purifying the water contained in the water tank 3.

More particularly, this phase is performed by the purifying means 23 placed inside the containment chamber 24.

The purifying means 23 so positioned, for example constituted by a UV lamp as above disclosed, and the water flow rate, that is not higher than 2 lt/min due to the low pressure with which water is transferred into the water tank 3, allows to obtain an efficient water purification because the UV rays are able to reach all the water particles contained in the water tank 3.

In the preferred form of embodiment showed in the figures, it is further necessary to replenish the reservoir 30, for example by removing it from the device 1, in order to allow the continuous preparation of cold water and soda.

It has in fact been ascertained how the described invention achieves the proposed objects and in particular the fact is underlined that the device according to the invention allows to prepare cold water and cold soda without using an high pressure pump.

More particularly, this is reached by using two separated liquid tank, one for water and one for soda, and by transferring water from the water tank into the soda tank, where in the latter is also injected CO₂. In this way there is no need for pumping water with high pressure, because the mixing of water and CO₂ is obtained by taking advantage of the CO₂ pressure. Therefore, it is possible to supply water and soda in a continuous way thanks to the fact that the water tank, the soda tank and the CO₂ tank are separated from each other and are all part of the device itself.

Furthermore, the device according to the present invention allows to obtain a more efficient cooling with respect to the known devices, due to the particular disposition of the cooling means.

Moreover, the device according to the present invention allows the purification of both water and soda before the same are supplied to the outside. More particularly, the low water flow rate, due to the absence of an high pressure pump, and the use of two different tanks, separated from the CO₂ tank, allows the purification of water before its mixing with CO₂.

Another advantage of the device according to the present invention is that it is of use considerably more flexible than the devices of known type. More particularly, the present device can be positioned everywhere, because, due to the presence of an external reservoir, its use is not limited to the presence of a domestic water line.

1. Device (1) for supplying water and soda, comprising:
at least a water feeding line (2);
at least a water tank (3) connected to said water feeding line (2);
at least a pressurized CO₂ tank (4);
at least a soda tank (5) separated from both said water tank (3) and said CO₂ tank (4), where the soda tank (5) is positioned around said water tank (3) or viceversa;
means for mixing (6, 7) water with CO₂ for obtaining soda which comprise means for transferring (6) water from said water feeding line (2) into said soda tank (5) and means for injecting (7) CO₂ from said CO₂ tank (4) into said soda tank (5);
first supplying means (8) communicating with said water tank (3) for supplying water towards outside;
second supplying means (9) communicating with said soda tank (5) for supplying soda towards outside;
and characterized in that it comprises cooling means (20) interposed between said water tank (3) and said soda tank (5).

2. Device (1) according to claim 1, characterised in that it comprises a cavity wall (22) interposed between said soda tank (5) and said water tank (3) and in that said cooling means (20) are disposed into said cavity wall (22) and shaped in such a way to round at least a portion of said water tank (3).

3. Device (1) according to claim 1, characterized in that said transferring means (6) are interposed between said water tank (3) and said soda tank (5) and are adapted for conveying water from the water tank (3) into the soda tank (5).

4. Device (1) according to claim 1, characterised in that said soda tank (5) is ring shaped and in that said water tank (3) is positioned substantially in the middle of said soda tank (5).

5. Device (1) according to claim 1, characterised in that it comprises means for purifying (23) the water contained in said water tank (3).

6. Device (1) according to claim 5, characterised in that it comprises a containment chamber (24) for said means for purifying (23) disposed inside said water tank (3) and separated from it.

7. Device (1) according to claim 6, characterised in that said purifying means (23) comprise at least an UV lamp and in that the wall (24a) of said containment chamber (24) that separates the containment chamber itself from said water tank (3) is made of a material at least partially transparent.

8. Device (1) according to claim 1, characterised in that said injecting means (7) comprise at least a couple of nozzle (25) positioned inside said soda tank (5) and oriented in opposite direction with respect to each other in order to create a vortex inside the soda tank (5).

9. Device (1) according to claim 1, characterised in that said injecting means (7) comprise at least a control valve (26) associated to said CO₂ tank (4) and connected to said soda tank (5), the control valve (26) being controllable for allowing/preventing the CO₂ leakage from said CO₂ tank (4) into said soda tank (5).

10. Device (1) according to claim 9, characterised in that said control valve (26) comprises a body (26a), associated to said CO₂ tank (4) and defining a CO₂ path (26b) communicating with said soda tank (5), at least a piston (26c) inserted inside said body (26a) and movable between a first position, in which said CO₂ tank (4) is closed, and a second position, in which opens said CO₂ tank (4) for allowing the transit of CO₂ into said CO₂ path (26b), at least a control chamber (26d) communicating with said piston (26c) and connected to said water feeding line (2) and means for controlling (28, 29) the inlet/outlet of the water into/from said control chamber (26d) for moving said piston (26c) from the first to the second position and vice versa.

11. Device (1) according to claim 1, characterized in that said injecting means (7) comprise at least a timer adapted to control the opening/closing of said control valve (26).

12. Device (1) according to claim 1, characterised in that said water feeding line (2) is connected at least to a reservoir (30) isolated from a fixed line (31) of domestic water and in that it comprises means for pumping (32) water from said reservoir (30) into said water feeding line (2).

13. Device according to claim 12, characterised in that said water feeding line (2) is connected to said reservoir (30) and is connectable to said fixed line (31) and characterised in that it comprises control means (35) suitable to activate said means for pumping (32).

14. Method for preparing water and soda, characterised on the fact of comprising the following steps of:
furnishing at least a water tank (3);
furnishing at least a soda tank (5);
furnishing at least a CO₂ tank (4);
filling said water tank (3) and said soda tank (5) with water;
injecting CO₂ from said CO₂ tank (4) into the water contained in said soda tank (5) for obtaining soda;
contemporary cooling the water contained in said water tank (3) and the soda contained in said soda tank (5).

15. Method according to claim 14, characterised in that it comprises the step of purifying the water contained in said water tank (3).

16. Device (1) according to claim 2, characterized in that said transferring means (6) are interposed between said water tank (3) and said soda tank (5) and are adapted for conveying water from the water tank (3) into the soda tank (5).
